(19) United States
(12) Patent Application Publication
(10) Pub. No.: US 2018/0347514 A1
(43) Pub. Date: Dec. 6, 2018

(54) EXHAUST GAS RECIRCULATION SYSTEM

(71) Applicant: Hanon Systems, Daejeon (KR)

(72) Inventors: Guillaume Hebert, Stare Mesto (CZ); Jiri Bazala, Korytná (CZ)

(21) Appl. No.: 15/978,675

(22) Filed: May 14, 2018

(30) Foreign Application Priority Data
May 30, 2017 (DE) 102017209037.5

(51) Int. Cl. F02M 26/07; F02M 26/25; F01N 3/10; F01N 3/021; F02M 31/20

(52) U.S. Cl. CPC F02M 26/07; F02M 26/25; F02M 31/20; F01N 3/021; F01N 3/10

(57) ABSTRACT

An exhaust gas recirculation system (12) comprises at least one exhaust gas recirculation line (13) which, in the direction of flow, branches off from an exhaust gas pipe (14) after an exhaust gas turbine (2) and/or a particulate filter (4) and/or a catalytic converter; in the direction of flow, opens out into a supply-air line (15) after a turbo-compressor (3) and comprises in its course at least one pump (11).

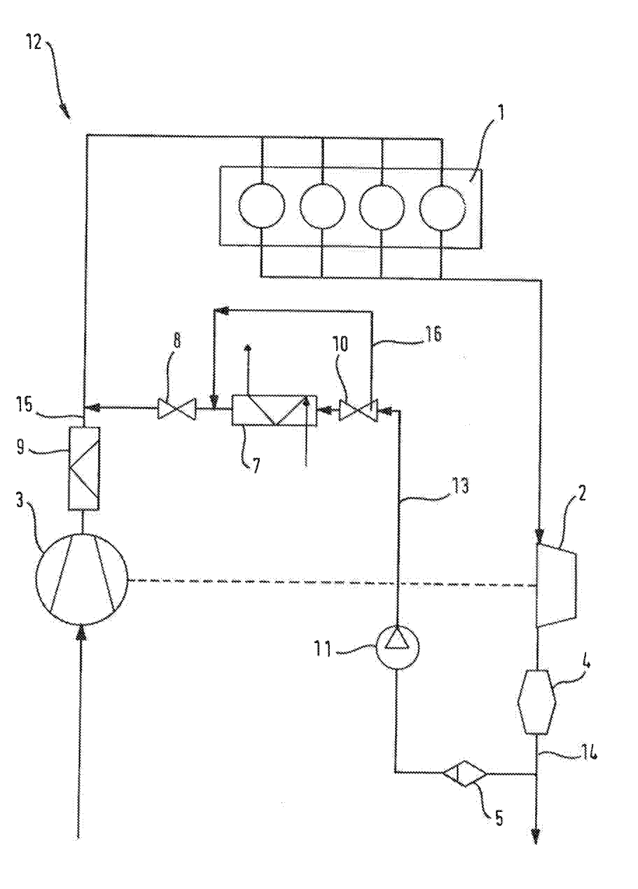

### FIELD OF TECHNOLOGY

The invention relates to an exhaust gas recirculation system (EGR),

### PRIOR ART

To reduce the emission of harmful substances, in particular of nitrogen oxide (NOₓ), it is known to recirculate a portion of the exhaust gas of an internal combustion engine back into the supply-air side. For this purpose high-pressure exhaust gas systems are, for example, known in which an exhaust gas recirculation line branches off essentially immediately after the engine, in particular before an exhaust gas turbine and a diesel particulate filter or catalytic converter. The recirculated exhaust gas has consequently a comparatively high temperature such that the reduction of the NOₓ emission is not optimal and, moreover, the efficiency of the engine is decreased through the exhaust gas recirculated at comparatively high temperatures. Especially under cold conditions of the engine, furthermore, the function of an exhaust gas regulation valve can be impaired by adhesions that can form out of the hot exhaust gas on a valve seat for example. In the case of a turbocharger [turbo-compressor] its efficiency is further impaired since the hot exhaust gases are returned downstream of the turbocharger. There is lastly the disadvantage for a diesel particulate filter in that it heats more slowly since hot exhaust gas is diverted upstream of the diesel particulate filter. The described high-pressure exhaust gas recirculation system, in comparison, offers the advantage that high recirculation rates are feasible due to the high pressure difference between inlet and outlet of the exhaust gas recirculation line.

Low-pressure exhaust gas recirculation systems are also known in which the exhaust gas recirculation line branches off downstream of an exhaust gas turbine and a diesel particulate filter or catalytic converter. However, due to the cooling of the exhaust gas, condensation of the water vapor may occur, which can have negative effects on a turbocharger. In the case of a charge-air cooler additional problems are engendered through the additionally cooled recirculated exhaust gas since acids may form leading to corrosion. Furthermore, especially at low ambient temperatures water droplets may be introduced into the cylinders of the internal combustion engine, which is undesirable. There is further the problem in such systems that the recirculated exhaust gas, due to the considerable cooling, cannot be utilized for the rapid warming of the engine. Lastly there exists a reduced pressure difference between the inlet and outlet of the exhaust gas recirculation line such that the exhaust gas recirculation rates are limited. In comparison, significant disadvantages described above for the high-pressure recirculation system can be avoided.

This applies similarly to known combinations of high-pressure and low-pressure exhaust gas recirculation systems in which, essentially on the high-pressure side, an exhaust gas recirculation line branches off which, after the turbocharger, opens out into the supply-air line, and also, on the low-pressure side, an exhaust gas recirculation line branches off before the turbocharger that opens out into the supply-air line. However, in this combination essentially two systems are provided which entails disadvantages in terms of expenditures, space requirements and the comparatively complex control of the involved valves.

### DESCRIPTION OF THE INVENTION

Against this background the invention addresses the problem of providing a cost-effective and/or space-saving exhaust gas recirculation system which eliminates at least some of the above described disadvantages of known systems.

The problem is resolved through the exhaust gas recirculation system described in Patent Claim 1.

Accordingly, the exhaust gas recirculation system comprises at least one exhaust gas recirculation line which, in the direction of flow, branches off after an exhaust gas turbine and/or a particulate filter and/or a catalytic converter. Stated differently, it branches off on the low-pressure side of an exhaust gas pipe. In contrast, it opens out into a supply-air line after a compressor in the direction of flow; stated differently, it opens out on the high-pressure side into a supply-air line and in its course comprises at least one pump to overcome the pressure difference. Consequently, a “lean and streamlined” system is provided that utilizes the above listed advantages of the exhaust gas recirculation from the low-pressure side, for example the advantage of efficient heating of a diesel particulate filter and the avoidance of contamination of a cooler or exhaust gas recirculation valve by particles. By having already filtered out particles, an exhaust gas recirculation valve can be provided in the low-temperature region, in other words after a cooler, which yields lower costs and allows the valve to be produced to be more robust. Thereby that the exhaust gas is recirculated to the high-pressure side, the described problems cannot occur in a charge-air cooler or turbocharger. In particular in combination with a cooler that can be circumvented through a bypass line, the exhaust gas can be utilized for rapidly warming the engine during the warm-up phase, while in the further course a substantial reduction of the NOₓ emissions and a high engine efficiency are feasible through low exhaust gas recirculation temperatures. Lastly, through the pump provided according to the invention the suction of the exhaust gas to be recirculated from the low-pressure side and a high exhaust gas recirculation rate are achieved. The system according to the invention can consequently be considered a “hybrid” between a low-pressure and a high-pressure exhaust gas recirculation system which largely avoids the disadvantages of the two systems while utilizing the advantages of both, as described above.

Preferred further developments of the exhaust gas recirculation system according to the invention are described in the additional claims.

Since it may occur that small ceramic particles are detached from a particulate filter or a catalytic converter, at least one filter is preferably provided upstream of the pump in order to avoid damaging the pump.

In the exhaust gas recirculation line is preferably provided, as stated, an exhaust gas cooler that is preferably disposed downstream of the pump.

Although it is in principle feasible to control the quantity of the recirculated exhaust gas through a suitable, for example proportional, pump control, in certain application cases advantages can be gained if in the exhaust gas recirculation line an exhaust gas recirculation valve is provided that is preferably disposed downstream of an exhaust gas cooler.

However, in order to utilize, depending on the operational state, the advantages of cooled or non-cooled exhaust gas, a bypass line is preferably provided that circumvents the exhaust gas cooler.

A bypass valve is herein preferably disposed upstream of the exhaust gas cooler.

To increase the engine efficiency a charge-air cooler is furthermore preferably provided.

In order to avoid problems, as described above, in the charge-air cooler through recirculated exhaust gas and possible condensate, the exhaust gas recirculation line preferably opens out into the supply-air line downstream of the charge-air cooler.

### BRIEF DESCRIPTION OF THE DRAWING

In the following an embodiment example of the invention depicted in the drawing will be described in further detail.

The FIGURE shows schematically the exhaust gas recirculation system according to the invention.

### DETAILED DESCRIPTION OF A PREFERRED EMBODIMENT OF THE INVENTION

As is shown in the FIGURE, an exhaust gas pipe 14 leads from an internal combustion engine 1, first through an exhaust gas turbine 2 and a diesel particulate filter 4 before the exhaust gas recirculation line 13 is branched off. For the purpose described above, in the exhaust gas recirculation line [13] is disposed, first, a filter 5, downstream thereof a pump 11, and further downstream a bypass valve 10 with a bypass line 16 branching off therefrom, circumventing cooler 7. Downstream of the cooler 7 the bypass line 16 opens out into the exhaust gas recirculation line 13 and before the opening-out site into the supply-air line 15 preferably, even though not mandatorily, an exhaust gas recirculation valve 8 is provided. As is further shown in the FIGURE, the exhaust gas recirculation line 13 opens out into the supply-air line 15 downstream of a turbocharger 3 and charge-air cooler 9, or, stated differently, on the high-pressure side. In contrast, the exhaust gas recirculation line 13 branches off from the exhaust gas pipe 14 on the low-pressure side such that the above described “hybrid” system with its advantages is obtained.

1.-8. (canceled)

9. An exhaust gas recirculation system with at least one exhaust gas recirculation line which, in the direction of flow, branches off after an exhaust gas turbine and/or a particulate filter and/or a catalytic converter from an exhaust gas pipe, in the direction of flow opens out after a turbo-compressor into a supply-air line and comprises in its course at least one pump.

10. An exhaust gas recirculation system as in claim 9, further comprising at least one filter in the exhaust gas recirculation line.

11. An exhaust gas recirculation system according to claim 9, further comprising an exhaust gas cooler in the exhaust gas recirculation line.

12. An exhaust gas recirculation system according to claim 9, further comprising an exhaust gas recirculation valve is provided in the exhaust gas recirculation line.

13. An exhaust gas recirculation system according to claim 11, further comprising a bypass line circumventing the exhaust gas cooler.

14. An exhaust gas recirculation system as in claim 13, further comprising a bypass valve upstream of the exhaust gas cooler.

15. An exhaust gas recirculation system according to claim 9, further comprising a charge-air cooler downstream of the turbo-compressor.

16. An exhaust gas recirculation system according to claim 15, wherein the exhaust gas recirculation line opens out into the supply-air line downstream of the charge-air cooler.

17. An exhaust gas recirculation system as in claim 12, further comprising a bypass line circumventing the exhaust gas cooler.

18. An exhaust gas recirculation system according to claim 10, further comprising an exhaust gas recirculation valve in the exhaust gas recirculation line.

19. An exhaust gas recirculation system according to claim 11, further comprising an exhaust gas recirculation valve in the exhaust gas recirculation line.

20. An exhaust gas recirculation system according to claim 10, further comprising a charge-air cooler downstream of the turbo-compressor.

21. An exhaust gas recirculation system according to claim 11, further comprising a charge-air cooler downstream of the turbo-compressor.

22. An exhaust gas recirculation system according to claim 12, further comprising a charge-air cooler downstream of the turbo-compressor.

23. An exhaust gas recirculation system according to claim 13, further comprising a charge-air cooler downstream of the turbo-compressor.

24. An exhaust gas recirculation system according to claim 14, further comprising a charge-air cooler downstream of the turbo-compressor.
